(19) United States
(12) Patent Application Publication
(10) Pub. No.: US 2006/0086703 A1
(43) Pub. Date: Apr. 27, 2006

(54) System and method for singulating a substrate

(76) Inventors: Ling Liu, Colorado Springs, CO (US); John F. Casey, Colorado Springs, CO (US); Regina N. Pabilonia, Colorado Springs, CO (US); James Drehle, Colorado Springs, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/920,631

(22) Filed: Aug. 18, 2004

(51) Int. Cl. B23K 26/00

(52) U.S. Cl. 219/121.72

(57) ABSTRACT

A laser cutting system includes a laser generating a laser cutting beam for singulating an electronic device from a substrate. A support block is laser machined to include a channel corresponding to an outline of the electronic device to be singulated. Also laser machined within the channel are slag removal vacuum ports. The slag removal vacuum ports are used to remove slag and hold small cutout during singulation. The support block also includes device vacuum ports for holding the electronic device in position after being singulated.

### BACKGROUND OF THE INVENTION

CO₂ laser systems have been used extensively to cut ceramic substrates and other similar materials. Traditionally, a ceramic substrate has been scribed using a CO₂ laser system along the perimeter of the sections of the ceramic substrate to be singulated; these sections corresponding to electronic circuits generally produced using thick film technologies. Prior art scribing processes have generally cut into the ceramic substrate about fifty per cent of the thickness of the ceramic substrate. After the ceramic substrate was scribed, the sections to be singulated were manually separated by breaking the ceramic substrate at the scribe lines. The cutting precision of these laser cutting systems was limited to electronic circuits which were large in comparison to the thickness of the ceramic substrate, as the scribe and break process had a typical tolerance of ±5 mils (0.127 mm). Also the edges of the singulated devices were rough due to the breaking process.

Low K dielectrics that are thick film screenable glass compounds are being used increasingly for thick film high frequency, low loss circuit applications. The low K dielectrics have been shown to be very brittle, and easy to crack by mechanical or thermal stress. Prior art laser systems have failed to cleanly cut dielectrics screened and fired onto ceramic substrate without generating micro-cracks, especially when the dielectric material is deposited on a metallic base material. These micro-cracks have been shown to lead to premature failure of electronic circuits, especially microwave circuits constructed using existing thick film technologies.

Thus what is needed is an apparatus for precisely separating electronic devices fabricated on substrates, such as ceramic substrates, as is increasingly needed for microwave hybrid circuits. What is further needed is an apparatus for singulating substrates upon which low K dielectrics are screened and fired upon the substrate. The apparatus for singulating substrates using low K dielectrics must prevent both mechanically and thermally generated micro-cracks from being formed in the low K dielectrics during the laser singulation process. What is also needed is an apparatus for precisely generating cutouts in electronic devices fabricated on substrates, especially when the cutouts include a low K dielectric.

### BRIEF DESCRIPTION OF THE DRAWINGS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description, like reference numerals are used to describe the same, similar or corresponding parts in the several views of the drawings.

FIG. 1 is a diagram of a support block in accordance with the present invention.

FIG. 2 is a sectional view of an exemplary channel machined into the support block and an exemplary slag removal hole in accordance with the present invention.

FIG. 3 is a diagram of a laser cutting system used to singulate an electronic device in accordance with the present invention.

FIG. 4 is a diagram of a substrate holder utilized in the laser cutting system in accordance with the present invention.

FIG. 5 is a diagram of an exemplary electronic device screened and fired on a ceramic substrate in accordance with the present invention.

FIG. 6 is a diagram illustrating the laser cut location in accordance with the present invention.

FIG. 7 is a sectional view illustrating the laser cut of FIG. 6.

FIG. 8 is a flow chart depicting a method for singulating electronic devices from a ceramic substrate in accordance with the present invention.

### DETAILED DESCRIPTION

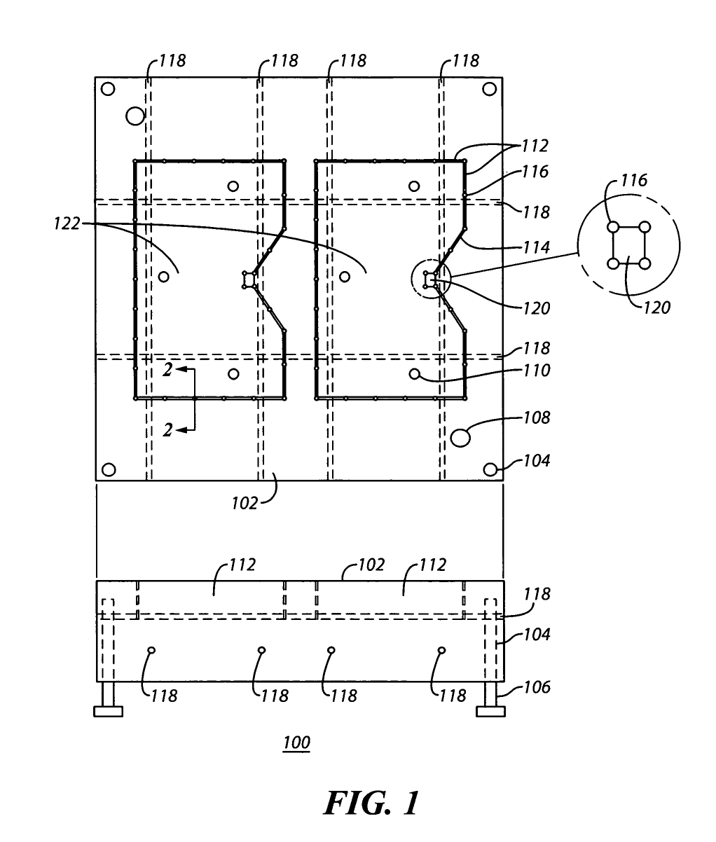

FIG. 1 is a diagram of a support block 100 in accordance with certain aspects of the present invention. The support block 100 is machined from a block 102 of Lexan® thermoplastic material, a polycarbonate resin manufactured by the General Electric Company of Pittsfield, Mass. The support block 100 will hereinafter be referred to as micro-block 102 throughout the instant specification, i.e. a plastic block has been machined in accordance with the present invention. Micro-block 102 in accordance with the present invention is square, having typical dimension of 3.5″ (88.9 mm)×3.5″ (88.9 mm)×1.0″ (25.4 mm) thick. It will be appreciated that the size of micro-block 102 is determined by the size of the ceramic substrate to be singulated, and may be larger or smaller in accordance therewith. Micro-block 102 has at each corner a hole 104 that is tapped to accept a screw 106. Screw 106 is for purposes of discussion a #10 pan head machine screw that is used to provide several functions. It will be appreciated that screw 106 may be larger or smaller depending upon the actual size of micro-block 102. Among the functions screw 106 provides is to level micro-block 102 with the surface of substrate holder 310, and to provide a space between the underside of micro-block 102 and the surface of mounting plate 318, described in FIG. 3. This space between micro-block 102 and mounting plate 318 is used to provide a vacuum manifold through which a vacuum is provided to the underside of micro-block 102, as will be described in detail later.

In addition to the corner holes 104, two additional holes 108 are provided which enable the removal of micro-block 102 from substrate holder 310. Micro-block 102 is customized for each electronic device to be singulated from a ceramic substrate. Typically three to four vacuum holes 110 are provided beneath each electronic device to be singulated. Vacuum holes 110 are provided within micro-block 102 to hold the electronic devices in place as the laser singulation process. Depending upon the shape of the electronic device to be singulated, channels are laser machined into the micro-block 102 as will be described later. These channels may be orthogonal channels 112, e.g. channels that are machined orthogonal to each other and corresponding to the edges of a square or rectangular electronic device, or non-orthogonal channels 114, corresponding to non-orthogonal edges of the electronic device. The channels in accordance with the present invention, whether they are orthogonal channels 112 or non-orthogonal channels 114 are machined using a laser cutting system 300, to be described in FIG. 3. Other methods of machining the channels which can conform with the requirements of the present invention can be utilized as well.

Within the channels described above are also machined slag removal holes 116 that are spaced regularly about the perimeter of the electronic device. The slag removal holes provide three functions, i.e. to provide removal of slag (metallic, dielectric or ceramic debris), to provide stress relief where corners are encountered, and prior to the ceramic substrate being cut to provide a vacuum to hold the electronic device in place.

Metallic rods 118, e.g. aluminum rods, are inserted into holes bored through micro-block 102. The metallic rods 118 are located within the boundaries of the perimeter of the electronic device and are used to strengthen micro-block 102 should the laser beam eventually cut through the thickness of micro-block 102. The holes into which the metallic rods 118 are inserted are preferably positioned one-third of the thickness of micro-block 102 below the upper surface, or one-third of the thickness of micro-block 102 above the lower surface of the micro-block 102 in order to maximize the integrity of the micro-block 102 and minimize interaction with the laser beam. Multiple metallic rods 118 may be inserted at the two levels orthogonal to each other, as shown in FIG. 1.

Metallic rods 118 are added to maximize the integrity of the micro-block 102, however, it will be appreciated that there may be instances when no metallic rods are utilized. When utilized, the metallic rods may only be utilized in the upper holes, the lower holes, or in a combination of both upper and lower holes.

In many instances, a small cutout is required in the ceramic substrate, such as cutout 120, that may generally have a rectilinear geometry, such as square or rectangular, and is often on an order of magnitude of the thickness of the ceramic substrate (0.040″ or 1 mm). Such cutout 120 is often generated to provide relief for an integrated circuit that is affixed to a mother board (not shown), which is then wire-bonded to pads provided on the electronic device fabricated in accordance with the present invention. When a small cutout, such as cutout 120, is required, it is important to provide stress relief at each corner of the cutout 120. For purposes of example a small cutout is one which has a length and width which is defined as generally equal to or less than five times the thickness of the ceramic substrate. Put another way, a cutout that would be susceptible to being easily dislodged by the high pressure air stream 306, and in the process either causing micro-cracks in the dielectric or should the cutout be broken loose would interfere with the laser cutting system movement and alignment. It will be appreciated that this definition of a small cutout is provided for example only, and the cutout length and width to ceramic thickness ratio may be larger or smaller when defining a small cutout. As shown, stress relief at the corners of the small cutout is provided by preferably positioning a slag removal hole at each corner of the cutout 120. The vacuum provided by the slag removal holes on the corners of cutout 120 helps to prevent the small cutout from prematurely breaking away during cutting and being dislodged by the high pressure air stream 306 and as a result potentially corrupt the laser beam 308 alignment. It will be appreciated that while only a single cutout 120 was described above for an electronic device, there are instances where more than one cutout 120 is needed within the same electronic device. The laser cutting system 300 in accordance with the present invention handles multiple small cutouts when singulating an electronic device.

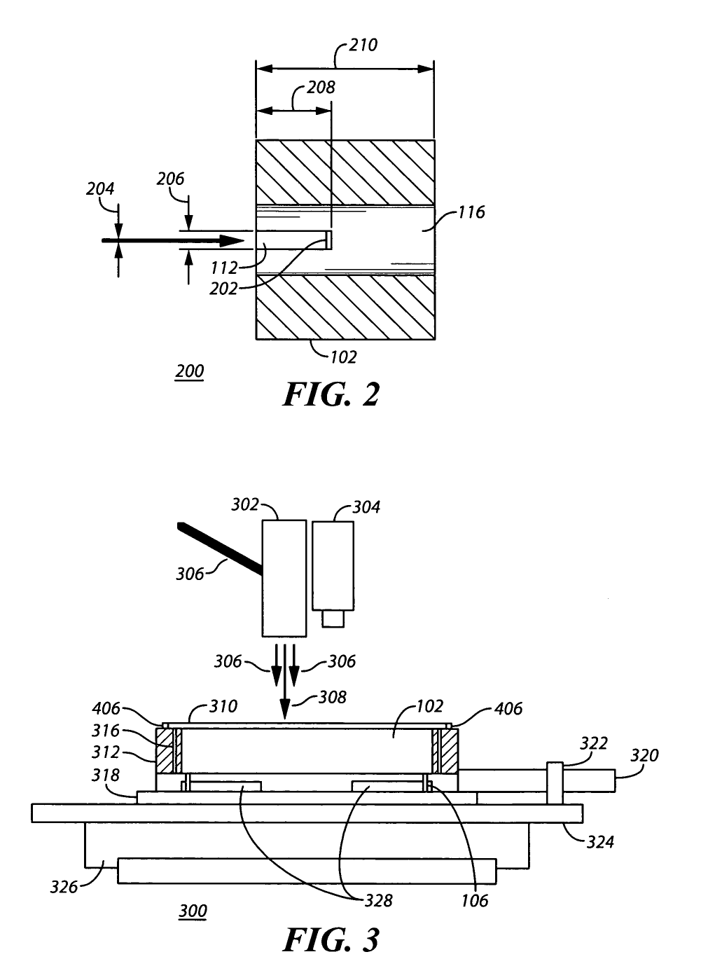

FIG. 2 is the sectional view 200 of an exemplary channel machined into micro-block 102 and an exemplary slag removal hole 116 in accordance with the present invention. The depth of the channel that is laser machined is preferably at least one-third the thickness of micro-block 102. This is represented by depth 208 as compared to the total thickness 210 of micro-block 102. It will be appreciated, depending upon the characteristics of the laser cutting system 300, depth 208 may be deeper or shallower than described above. In addition, the channel width 206 is preferably at least three times the laser beam width 204 used in the laser cutting system 300, wherein the mean of the channel width 206 corresponds generally to the outline of the electronic device to be singulated. It will be appreciated that the channel width 206 may also be greater or smaller than described above. The channel width 206 is dependent upon the characteristics of the laser cutting system 300, and the capability of the laser cutting system 300 to image and correct the position and orientation of the electronic device as will be described later.

An important aspect of the present invention is depositing of a laser beam dispersing material 202 within the channel machined into the upper surface of the micro-block 102. After laser machining the channel, laser beam dispersing material, e.g. aluminum foil, gold flakes, or the like, is placed into the machined channel. The laser beam dispersing material 202 minimizes further cutting of the channel within micro-block 102 by the laser beam. Over time, however, some deterioration of the channel will occur through heating of the plastic material due to the unfocused laser beam repeatedly sweeping through the channel. Without the laser beam dispersing material 202, the useful life of the micro-block would be very short, i.e. only a limited number of ceramic substrates would be able to be singulated before the micro-block 102 would have to be changed. With the inclusion of the laser beam dispersing material 202, hundreds of ceramic substrates can be singulated during the useful life of the micro-block 102.

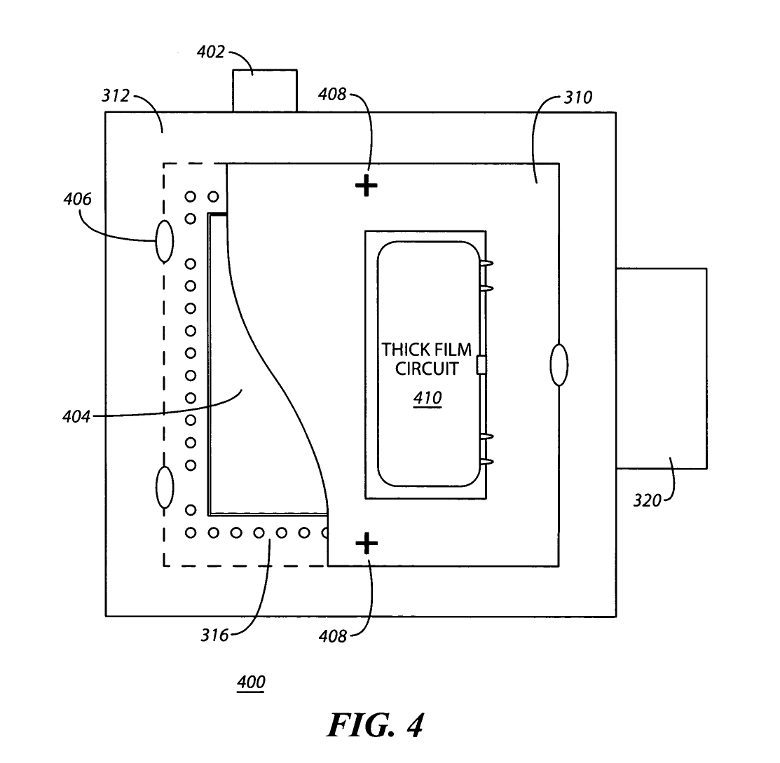

FIG. 3 is a diagram of the laser cutting system 300 utilized for singulating an electronic device, such as electronic device 410 shown in FIG. 4. While electronic device 410 has a rectangular outline, it will be appreciated that the outline may be non-rectangular as well as depicted by the outline 122 shown in FIG. 1. When an electronic device is to be referred to anywhere in the instant specification, the electronic device shall be referred to as electronic device 410, realizing the actual shape of the electronic device may be not always be rectangular, and may have different uses.

The laser cutting system 300 utilizes a laser 302 capable of cutting through a ceramic substrate 310, a dielectric, and in some instances metallization that is screen and fired onto the ceramic substrate 310 or the dielectric as will be described in further detail in FIG. 7 below. An exemplary laser system suitable for cutting the ceramic substrate 310, dielectric and metallization is a CO₂ laser, such as a Coherent Diamond K-150 CO₂ Laser manufactured by Coherent Laser Division located in Santa Clara, Calif. A vision system 304 is provided in the laser cutting system 300 to assist in accurately aligning the laser beam using alignment patterns screened and fired onto the ceramic substrate 310. An exemplary vision system 304 utilizes a Panasonic Model No. KR222 video camera manufactured by Panasonic Vision Systems.

Compressed air is provided to the laser 302 and is delivered as an high pressure air stream 306 which clears the slag as the laser beam 308 cuts through the ceramic substrate 310, insulator, and metallization in accordance with the present invention. The compressed air pressure utilized in accordance with the present invention can be from 30 psi to 80 psi. The actual compressed air pressure that is utilized within the given range of compressed air pressures specified is dependent upon such factors as the electronic device to be singulated, e.g. the ceramic substrate composition and thickness, as well as the particular dielectric being used and the thickness of the dielectric and metallization layers.

A substrate holder 312 is attached to a mounting plate 318. The mounting plate 318 is attached to a base plate 324 that is mounted on an X-Y table 326. The positioning of the X-Y table 326 is precisely controlled by a laser system controller, such as a computer (not shown) in a manner well known to one or ordinary skill in the art. The computer controls linear stepper motors (not shown) within the X-Y table 326. Under the control of the computer the X-Y table 326 is moved at a rate of speed suitable to singulate an electronic device 410 from the ceramic substrate 310. The computer also controls the machining of the micro-block 102 as will be described below.

Attached to the substrate holder 312 is a rectangular vacuum nozzle 320 that is held in place relative to the substrate holder 312 by a clamp 322 attached to the base plate 324. The vacuum nozzle 320 is connected through a flexible hose to a Torit® dust collection system manufactured by the Donaldson Company, Inc. of Minneapolis, Minn. Air intakes 328 provide air to help sweep out the slag which includes ceramic, metallization and dielectric debris generated during singulation through the vacuum manifold generated between the bottom of the micro-block 102 and the mounting plate 318. The substrate holder 312 accepts the micro-block 102 machined to correspond to the pattern of the electronic circuits to be singulated. The ceramic substrate 310 rests on the top surfaces of the micro-block 102 and the substrate holder 312. The substrate holder 312 includes vacuum holes 316 that will be described in further detail below. The vacuum holes 316 are used to initially retain the ceramic substrate 310 as the laser cutting process proceeds, and once the singulation has been completed are used to retain the excess ceramic substrate, otherwise known by one of ordinary skill in the art as the “wings”. As mention above, the space between the bottom of the micro-block 102 and the top of the mounting plate 318 provides a vacuum manifold that couples the vacuum generated by the dust collecting system to the device vacuum holes 110 and slag removal vacuum holes 116. The device vacuum holes 110 hold the electronic device 410 from being displaced by the high-pressure air stream 306 as the electronic device 410 is being singulated from the ceramic substrate 310.

FIG. 4 is a diagram 400 of substrate holder 312 utilized in the laser cutting system 300 in accordance with the present invention. The substrate holder 312 includes an aperture 404 into which is placed the micro-block 102. As was described above, the top surface of the micro-block 102 is leveled to the top surface of the substrate holder 312. The substrate holder 312 includes vacuum holes 316 that are regularly positioned around three sides of the perimeter of aperture 404. Vacuum to the vacuum holes 316 is provided through a vacuum port 402. The vacuum port 402 is by way of example a female quick-disconnect fitting that enables a flexible ⅜ inch (9.5 mm) vacuum line to be connected to a vacuum system. The substrate holder 312 also includes a number of alignment pins 406 that are used to initially locate the ceramic substrate 310 on the substrate holder. As was described above, alignment marks, such as an alignment mark 408, are used by the vision system 304 to provide fine alignment of the laser cutting beam 308 to the electronic device 410 to be singulated.

Also shown in FIG. 4 is the rectangular vacuum nozzle 320 used to supply vacuum from the Torit® dust collection system to the device vacuum holes 110 and slag vacuum holes 116 within micro-block 102. In practice it has been found that the vacuum provided through vacuum port 402 to vacuum holes 316 is not always needed. In many instances, the vacuum provided from the Torit® dust collection system to the device vacuum holes 110 and slag vacuum holes 116 is sufficient to securely hold the ceramic substrate 310 and electronic device 410 in place during and after completion of the singulation.

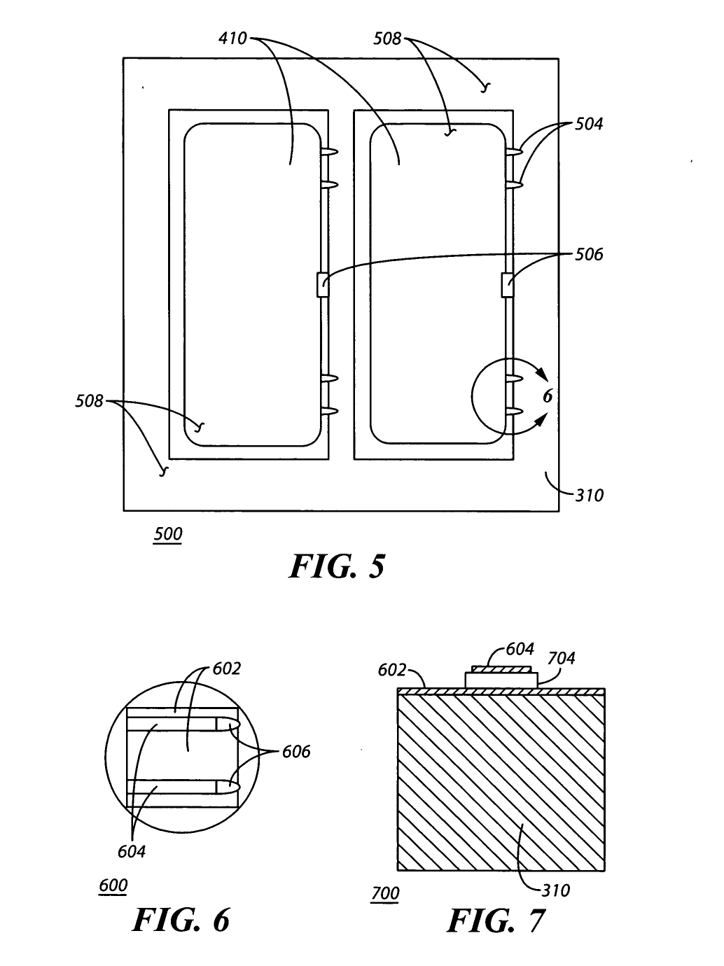

FIG. 5 is a diagram 500 of an exemplary electronic device 410 screened and fired on a ceramic substrate 102 in accordance with the present invention. Unlike the electronic device shown in FIG. 1, the electronic device 410 shown in FIG. 5 is rectangular. It will be appreciated that the shape and number of electronic devices that can be screened and fired onto the ceramic substrate 102 is based largely on the complexity of the electronic circuit. It will also be appreciated that the micro-block 102 is custom laser machined to correspond to the size, shape and number of electronic devices being singulated in accordance with the present invention. As shown in FIG. 5, the dielectric and metallization 504 often extend beyond the singulated edges of the electronic device. Also as shown in FIG. 5, the electronic device 410 includes a small cutout 506 that must have slag removal vacuum holes positioned at the corners as described above.

The entire surface of the ceramic substrate 310 and electronic device 410 is coated with a poly vinyl alcohol solution, used in the prior art as a solder mask, and is now used in the present invention as a slag mask 508. Slag mask 508 captures laser slag that is not removed by the vacuum system or by the high pressure air stream 306 applied to the surface of the ceramic substrate while the laser beam 308 is cutting. The poly vinyl alcohol solution is preferably Photomask Coating 2060, sold as a protective polymer coating designed to increase photomask life, is manufactured by Transene Co. located in Rowley, Mass. It will be appreciated that other similar poly vinyl alcohol solutions from other manufacturers that are often used as solder masks may be utilized as well. It has been found that the slag re-deposited on the surface of the electronic device in the vicinity of the laser cut is almost impossible to remove, and interferes with further processing of the electronic device, e.g. wire bonding. The poly vinyl alcohol solution used to form the slag mask 508 is easy to deposit on the ceramic substrate 310 ready to be singulated, is readily cut by the laser beam 308, is robust enough to catch and hold the slag not blown away by the high pressure air stream 306 or vacuumed through the slag vacuum holes 116, and washes away readily with water as will be described below.

In the preferred embodiment of the present invention, the slag mask 508 is applied using a brush, although it will be appreciated that other methods of application can be utilized as well, such as a spray system. Since the poly vinyl alcohol solution utilized is clear, it has been found that the addition of a vegetable coloring, or similar water-soluble dye is desirable. Once the electronic devices have been singulated from the ceramic substrate, the slag mask 508 can be completely washed free from the surface of the electronic device 410 as a result of the added coloring. Any colored residue remaining is an indication that washing is incomplete.

FIG. 6 is a diagram 600 illustrating the laser cut in accordance with the present invention, and FIG. 7 is a sectional view 700 illustrating the completed laser cut of FIG. 6. Referring to FIG. 6 and FIG. 7 an electronic device often consists of a ground plane 602 upon which is screened and fired a dielectric 702. Upon the dielectric 702 is often screened and fired a conductor 504. A detailed description of the processes by which the dielectric and conductors are screened and fired onto the ceramic substrate, in the absence and presence of a ground plane is disclosed in U.S. patent application Ser. No. 10/601042, filed Jun. 19, 2003, entitled “Methods for Forming a Conductor on a Dielectric” to John F. Casey, et al. (Docket No. 1003074-1), and U.S. patent application Ser. No. 10/600600, filed Jun. 19, 2003, entitled “Methods for Depositing a Thick Film Dielectric on a Substrate” to John F. Casey, et. al. (Docket No. 10030747-1), both applications of which are incorporated by reference herein.

As shown in FIG. 7 the laser cutting system 300 of the present invention is required to often cut through a conductor 604, a dielectric 702, a ground plane 602 and the ceramic substrate 310. It is required that the laser cutting system 300 cut cleanly and completely through the ceramic substrate 310. It is further required that the laser cutting system 300 cut cleanly through the ceramic substrate 310, the conductor 604, the dielectric 702, and ground plane 702, and in the process avoid micro-cracking of the dielectric 702. The laser beam cutting parameters which have been found to be effective are as follows: pulse period 3000-7000 microseconds, pulse width 75-500 microseconds, and cutting speed 0.0050-0.0500 inch/second. It will be appreciated that the actual pulse period, pulse width and cutting speed utilized are based on the specific ceramic substrate, dielectric, and conductor materials and thickness being used.

The ceramic substrate 310 is preferably a 96% Al₂O₃ (alumina) ceramic. Alumina ceramic is essentially a composite of fine-grained poly-crystals held together at their grain boundaries. The existence of this multitude of randomly oriented grain boundaries has the desirable effect of interfering with the propagation of cracks within the ceramic. Thus cracking of the ceramic substrate edges during singulation is generally not a problem encountered neither in the laser cutting system 300 of the present invention, nor in most prior art laser cutting systems. The conductor 604 and ground plane 702 metallization in the electronic device 310 in accordance with the present invention is preferably gold. Such metallization system is generally very difficult to cut, even with a CO₂ laser system unless the laser beam power provided is sufficient to overpower the reflectance of the metallization and cut through the metallization. The dielectric 704 is a low K dielectric having a dielectric constant less than 5. A suitable low K dielectric is KQ CL-90-7858 dielectric (a glass dielectric) available from Heraeus Cermalloy (West Conshohocken, Pa.) which has a dielectric constant of 3.95. However, the dielectric 704 may be another dielectric and, particularly, may be another low K glass dielectric with suitable electrical properties. The dielectric 702 is inherently weaker in tension than in compression. The dielectric 702 has been found to generally cut cleanly when the laser beam 308 cuts through the dielectric 702, but as the laser beam 308 encounters any metallization layer below the dielectric 702, the laser beam 308 heats the metallization, expanding it laterally, thus placing the already cut dielectric 702 into tension. Such tension will result in micro cracking unless the heating of the base metallization while singulating the ceramic is properly controlled. In this regard, the channel which has been laser machined in micro-block 102, and which includes slag vacuum holes 116 reduce the micro-cracking potential by enabling air to be swept by the edges of the electronic device thereby controlling the heating of the base metallization, as the electronic device is being singulated.

Movement of the electronic device, as described above, can also initiate micro cracking, as it is being singulated. As described above, the movement of the micro-block 102 is constrained by the device vacuum holes, and to a lesser extent by the slag vacuum holes in accordance with the present invention.

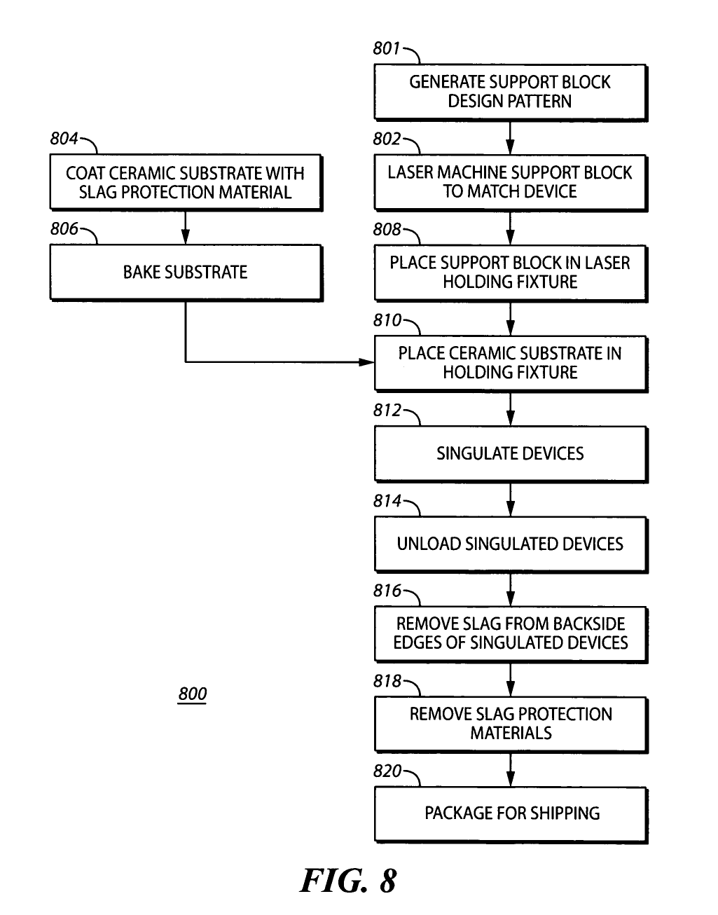

FIG. 8 is a flow chart 800 depicting the method for singulating an electronic device 410 from a ceramic substrate 310 in accordance with the present invention. As described above in FIG. 1, the method for singulating an electronic device begins at step 802 by generating a micro-block design pattern. The micro-block design pattern matches the outline, number, and position of the electronic devices 410 present on the ceramic substrate 310 to be singulated. The micro-block design pattern locates the channels representing the perimeter of the electronic devices to be laser machined, and the position and number of slag holes to be laser machined into the channels. The position of stress relief slag holes is also determined. Stress relief slag holes are those slag holes that are positioned at the transitions or corners between orthogonal and non-orthogonal perimeter segments. The number, and position of device vacuum holes is also determined, three or four device vacuum holes per electronic device depending upon the size of the electronic device present on the ceramic substrate. It will be appreciated that larger electronic devices may need more device vacuum holes, and smaller electronic devices may require fewer vacuum holes. The position and number of metallic strengthening rods is also determined at this time. The metallic strengthening rods can be located at one of two levels, one-third of the thickness of the micro-block 102 below the top surface of the micro-block 102 or one-third of the thickness of the micro-block above the bottom surface of the micro-block 102. The metallic strengthening rods are positioned so as not to be directly beneath and parallel to any long perimeters segments of the electronic device. Small rectangular or square cutouts anywhere along the perimeter of the ceramic substrate must also be considered, and stress relief slag holes are positioned in the micro-block 102 at each corner of any small cutout.

Once the micro-block design pattern has been completed, a pre-machined micro-block blank is obtained and the four leveling screws are inserted. The micro-block with leveling screws inserted is placed into the laser cutting system 300 and leveled with the top surface of the substrate holder. The pre-machined micro-block blank is a plastic block having the width, length and thickness dimensions of the final micro-block, as well as having the four corner holes for the leveling screws and two removal holes pre-machined, The four corner holes are tapped to accept the leveling screws.

The pre-machined micro-block blank is machined in the laser cutting system 300 exactly as it will be used when the laser cutting system 300 is singulating the electronic devices from the ceramic substrates. This insures the depth and width of the perimeter channels and placement of the slag holes, etc. are in accordance with the micro-block design pattern, and further correspond to the precise laser beam positions utilized to singulate the electronic devices from the ceramic substrate. A perimeter channels are cut to a depth preferably one-third the thickness of the micro-block and to a width preferably three times the laser beam width as described in FIG. 2 above. Following the laser machining, the support block blank is removed from the laser holding fixture, referred to above as the substrate holder, and completely cleaned. The perimeter channels are next filled with a laser beam dispersing material, being mindful that the slag holes are not obstructed. The finished support block can then be placed back into the laser holding fixture, at step 808.

Ceramic substrates that have been fabricated with the thick film electronic device are first coated with the slag protection material referred to above as the slag mask, at step 804. The ceramic substrate with the slag mask is baked preferably at 85° C. for approximately 30 minutes at step 806, or according to the manufacturer's specification. Completed ceramic substrates are then placed in the laser holding fixture as described above, at step 810. The laser cutting system 300 is then used to singulate the electronic devices, at step 812. The singulated electronic devices are next removed from the laser holding fixture. Since it is impossible to singulate the electronic devices without leaving some slag clinging to the bottom surface of the electronic device, this residual slag is easily removed by using a raw ceramic substrate as a scraper and scraping the edges on the bottom surface of the electronic device, at step 816. The singulated electronic devices are next washed in a warm water bath in which nitrogen is bubbled through the warm water, at step 818. The turbulence generated by the nitrogen assists in removing the slag mask and captured slag from the top surface of the electronic device. After a visual check to insure all slag mask has been removed, and all slag has been removed from the bottom edges of the electronic device, the cleaned electronic circuits are dried in an oven preferably at 85° C. for approximately 15 minutes. The dried electronic circuits are then packaged for shipping, at step 820.

Unlike prior art laser cutting systems, the laser cutting system 300 in accordance with certain embodiments of the present invention cuts completely through the ceramic substrate 310 as well as through any dielectric and metallization that may be in the path of the laser cutting beam 308. The micro-block 102 plays an important part in singulating the electronic device 410, as the vacuum holes 110 in micro-block 102 are key to holding the electronic device in place. By maintaining the position of the electronic device 410 as it is singulated from the ceramic substrate 310, and by properly maintaining the parameters of the laser cutting beam 308, micro-cracking of the dielectric is avoided.

In summary what has been described above is a laser cutting system 300 that includes a laser 302 generating a laser cutting beam 308 for singulating an electronic device 410 from a ceramic substrate 310. A micro-block 102 is laser machined to include a channel that may have orthogonal segments 112 and non-orthogonal segments 114 corresponding to an outline of the electronic device 410 to be singulated. Laser machined within the channel 112, 114 are also slag removal vacuum ports 116. The slag removal vacuum ports 116 are used to remove slag and when a small cutout 120 is required, hold the small cutout 120 during singulation. The support block 102 also includes device vacuum ports 110 for holding the electronic device 410 in position during and after being singulated. Laser beam dispersing material 202 is placed in the channel 112, 114 to retard cutting of the support block 102 by the laser cutting beam 308 during singulation. The laser cutting system 300 can also singulate the electronic device 410 cleanly without creating micro cracks in dielectric materials 704 when used in conjunction with a metallization 602, 604 that is used in fabricating the electronic device 410 on the ceramic substrate 310 being singulated. The electronic device 410 may comprise one or more cutouts 120 that when singulated and dislodged can become a problem to the alignment of the laser cutting system 300. The micro-block 102 is further laser machined to include slag removal vacuum ports 116 at the corner of the cutouts 120 to prevent the cutout from being dislodged during singulation. The device vacuum ports 110 hold an electronic device that includes at least first metallization pattern deposited on the ceramic substrate and a dielectric pattern deposited on at least a portion of said first metallization pattern. The dielectric pattern may also a second metallization pattern deposited on at least a portion of the dielectric pattern. The device vacuum ports 110 hold the electronic device 410 as the electronic device 410 is being singulated, and in combination the channel 112, 114 and the slag vacuum ports 116 are used to prevent micro-cracking of the dielectric as the dielectric is cut by the laser cutting system 300.

While the present invention has been described above as being applicable for singulating electronic devices from various substrates, such as ceramic substrates, and in particular for singulating electronic devices fabricated using low K dielectrics having a dielectric constant less than 5, it should be appreciated that the present invention can be utilized to singulate electronic devices using higher K dielectrics as well. When using higher K dielectrics in the fabrication of the electronic devices, consideration must be taken that the higher K dielectric is environmentally stable, and remains environmentally stable once cut with the laser cutting system in accordance with the present invention.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

We claim:

1. A laser cutting system, comprising:
a laser providing a laser cutting beam for singulating an electronic device fabricated on a substrate; and
a support block having a channel corresponding to an outline of said electronic device to be singulated, said channel including a plurality of slag removal vacuum ports,
said support block further comprising a plurality of device vacuum ports for holding said electronic device in position after said electronic device is singulated from the substrate.

2. The laser cutting system according to claim 1, wherein said substrate has a predetermined thickness, and wherein said laser cutting beam cuts through said predetermined thickness of said substrate to singulate said electronic device from said substrate.

3. The laser cutting system according to claim 1, wherein said support block has a predetermined thickness, and wherein said laser cutting beam cuts said channel to a depth of at least one-third of said predetermined thickness of said support block.

4. The laser cutting system according to claim 1, wherein said laser cutting beam has a predetermined beam width, and wherein said channel is cut to at least three times said predetermined beam width.

5. The laser cutting system according to claim 1, wherein a laser beam dispersing material is disposed in said channel, said laser beam dispersing material retarding cutting of said support block by said laser cutting beam.

6. The laser cutting system according to claim 1, wherein said plurality of device vacuum ports comprises at least three vacuum ports for said electronic device.

7. The laser cutting system according to claim 1, wherein said plurality of slag removal vacuum ports are regularly distributed about said outline of said electronic device.

8. The laser cutting system according to claim 7, wherein said outline of said electronic device has at least four corners, and wherein each of said at least four corners are orthogonal corners.

9. The laser cutting system according to claim 7, wherein one of said slag removal vacuum ports that are regularly distributed about said outline of said electronic device is located at each of said one or more orthogonal corner of said outline of said electronic device.

10. The laser cutting system according to claim 8, wherein said outline of said electronic device further has one or more non-orthogonal corners.

11. The laser cutting system according to claim 10, wherein at least one of said slag removal vacuum ports that are regularly distributed about said outline of said electronic device is located at each of said one or more non-orthogonal corners of said outline of said electronic device.

12. The laser cutting system according to claim 7, wherein said substrate has a predetermined thickness, and further wherein said outline of said electronic device includes at least one rectilinear cutout that is a multiple of said predetermined thickness.

13. The laser cutting system according to claim 7, wherein said multiple of said predetermined thickness is five.

14. The laser cutting system according to claim 12, wherein a slag removal port is located at each corner of said rectilinear cutout.

15. The laser cutting system according to claim 1, wherein said electronic device comprises:
a first metallization pattern deposited on said substrate;
a dielectric pattern deposited on at least a portion of said first metallization pattern; and
a second metallization pattern deposited on at least a portion of said dielectric pattern.

16. The laser cutting system according to claim 15, wherein said dielectric pattern comprises a low K glass dielectric material having a dielectric constant less than 5.

17. The laser cutting system according to claim 15, wherein said first metallization pattern comprises a gold material, and further wherein said second metallization pattern comprises a gold material.

18. The laser cutting system according to claim 15, wherein said laser cutting beam further cuts through said first metallization layer, said dielectric, and said second metallization layer when singulating said electronic device from said substrate.

19. The laser cutting system according to claim 1, wherein said substrate including said electronic device is coated with a slag mask to capture slag generated by said laser cutting beam and to prevent adhesion of said slag to said electronic device.

20. The laser cutting system according to claim 19, wherein said slag mask is a poly-vinyl alcohol solution.

21. The laser cutting system according to claim 19, wherein said poly vinyl alcohol solution is water soluble and clear, and wherein a water soluble dye is used to color said poly-vinyl alcohol solution.

22. The laser cutting system according to claim 19, wherein said slag mask is removed from said electronic device after said electronic device is singulated from said substrate.

23. The laser cutting system according to claim 1 further comprising at least one strengthening rod for strengthening said support block as said laser cutting beam singulates said electronic device from said substrate.

24. The laser cutting system according to claim 23, wherein said support block has a top surface and a predetermined thickness, and wherein said at least one strengthening rod is positioned within said support block at a location one-third the predetermined thickness of said support block below said top surface.

25. The laser cutting system according to claim 23, wherein said support block has a bottom surface and a predetermined thickness, and wherein said at least one strengthening rod is positioned within said support block at a location one-third the predetermined thickness of said support block above said bottom surface.

26. The laser cutting system according to claim 23, wherein said at least one strengthening rod is positioned with said support block within said outline of said electronic device.

27. A method for cutting a substrate comprising:
generating a support block design pattern corresponding to an outline of a device to be singulated by a laser cutting system;
machining a channel corresponding to said support block design pattern into a support block blank using a laser cutting system;
placing said laser machined support block into a holding fixture for a laser cutting system; and
singulating an electronic device from the substrate disposed on said machined support block and said holding fixture using said laser cutting system.

28. The method for cutting a substrate according to claim 27 further comprising laser machining a plurality of slag removal vacuum ports within said laser machined channel.

29. The method for cutting a substrate according to claim 27 further comprising placing a means for displacing a laser beam within said channel to retard cutting of said machined support block by said laser cutting system.

30. The method for cutting a substrate according to claim 27 further comprising laser machining a plurality of device vacuum ports used for holding said device.

31. The method for cutting a substrate according to claim 27 wherein said laser cutting system cuts through said substrate when singulating said electronic device.

32. The method for cutting a substrate according to claim 27, wherein said outline of said electronic device comprises at least one cutout, and wherein said support block design pattern includes an outline of said at least one cutout which is laser machined as a channel into said support block blank.

33. The method for cutting a substrate according to claim 32 wherein said at least one cutout has four corners, and further wherein said laser cutting system machines a slag removal vacuum ports at each of said four corners.

34. A laser cutting system, comprising:
a means for singulating an electronic device fabricated on a substrate; and
a means for supporting said electronic device having a channel corresponding to an outline of said electronic device to be singulated, said channel including a means for slag removal within said channel,
said means for supporting said electronic device further comprising means for holding said electronic device in position after said electronic device is singulated from the substrate.

35. The laser cutting system according to claim 34, further comprising a means for holding a cutout being removed from the electronic device being singulated.

36. The laser cutting system according to claim 34, wherein said electronic device comprises:
a first metallization pattern deposited on said substrate;
a dielectric pattern deposited on at least a portion of said first metallization pattern; and
a second metallization pattern deposited on at least a portion of said dielectric pattern.
